(19) United States
(12) Patent Application Publication
(10) Pub. No.: US 2023/0353553 A1
(43) Pub. Date: Nov. 2, 2023

(54) Method and System for Enabling Drive Features Using Secure Certificates

(71) Applicant: Rockwell Automation Technologies, Inc., Mayfield Heights, OH (US)

(72) Inventors: Todd A. Wiese, Hubertus, WI (US); Jonathan A. Mills, Mayfield Heights, OH (US)

(21) Appl. No.: 17/730,674

(22) Filed: Apr. 27, 2022

(51) Int. Cl. H04L 9/40

(52) U.S. Cl. CPC H04L 63/0823

(57) ABSTRACT

A secure certificate is provided to enable features within a motor drive. The certificate enables secure delivery of features for execution on the motor drive. A private key is stored in the motor drive, and the secure certificate is encrypted by the supplier with a corresponding public key. The encrypted certificate is delivered via a secure channel to the motor drive. The motor drive decrypts the certificate and reads the desired features for inclusion in the motor drive from extensions defined within the certificate. The motor drive downloads instructions for execution on the motor drive as well as configuration parameters required to execute the desired features. The instructions and parameters are stored in the memory of the motor drive for subsequent execution. Identification of features by secure certificate allows for feature and time-based licensing of functions for execution by the motor drive.

### BACKGROUND INFORMATION

The subject matter disclosed herein relates to a method and system for provisioning features in a motor drive. More specifically, a secure certificate is loaded into a motor drive in which the secure certificate includes a list of features to be included in the motor drive. The motor drive reads the list of features from the secure certificate and obtains firmware to execute the identified features.

Motor drives are commonly paired with an industrial controller. The industrial controller includes a control program to control an industrial machine or process. The controlled machine or process includes at least one motor requiring a motor drive for operation. Historically, the industrial controller has been configured to execute routines, or modules, related to system-level functions, and the motor drive has been configured to execute motor control routines related to smooth rotation of the motor. The system-level functions executing on the industrial controller include features entirely unrelated to a motor, such as monitoring sensors or enabling solenoids in the controlled machine or process. The system-level functions may also include some features related to operation of the motor such as a “flying start” feature, which detects if a motor is rotating before starting control of the motor, or a brake control feature, which controls operation of a holding brake connected to the motor. In contrast, the motor control routines include, for example, a current regulator to control current supplied to the motor or a position regulator to control angular position of the motor. The motor control routines further control modulation of the power electronic devices and other necessary functions to output a desired voltage and/or current to control rotation of the motor.

Over time, the processing ability and storage capacity within motor drives increased. Certain system-level functions were implemented within the motor drive to provide enhanced functionality within the motor drive and to reduce the programming requirements of the control program executing on the industrial controller and interfacing with the motor drive. For example, a motor drive could incorporate the “flying start” function into the motor drive. The flying start function implemented in the motor drive may use a position feedback signal provided to the drive to not only detect whether a motor is rotating but also to identify the angular velocity and position of the motor and to output a voltage waveform at the appropriate electrical frequency and angle corresponding to the rotation of the motor for improved start-up control of the motor when the motor is already rotating prior to control by the motor drive.

Implementation of system-level functions within the motor drive has proved desirable. A general-purpose motor drive may be configured to achieve more specialized operation by incorporating system-level functions. For example, features may be implemented to synchronize rollers in an extruder, to detect rollback at start or stop of a motor for vertical lifting applications, or to detect a stalled motor in a conveyor system. Still other features may be utilized for network communications, energy management, or event logging. Each of these functions provides improved flexibility for the applications in which a motor drive may be implemented and/or reduce the programming requirements of the system level controller.

It is also contemplated that different motor control routines may be included in a single motor drive, such as open-loop control, closed loop control, servo control, or the like. While each of these functions are considered part of the motor control, each offers a different complexity and different level of performance. Additional parameters, such as encoder parameters, are required to define desired closed loop control in contrast to open loop control. Including multiple motor control routines in a single motor drive provides improved flexibility for the applications in which the motor drive may be implemented and provides familiarity with one product for an end user regardless of the motor control requirements of an application.

However, inclusion of all these features within a motor drive has not been without certain drawbacks. As the number of features incorporated in the motor drive has grown, the commissioning and start-up of the motor drive has grown more complex. The number of parameters required to configure all of the different features may grow to thousands. Menu trees for accessing each of the different functions become more difficult to follow. Further, the motor drive must be configured in all instances to have sufficient storage and processing capacity to execute all of the different features. However, in many applications, a single motor control routine is selected and only a small percentage of the system level functions are required. Thus, the memory and processing capacity in a motor drive are often substantially greater than that required for a particular application. The additional features and excess processing and memory capacity create additional complexity and expense in the motor drive for many applications.

Thus, it would be desirable to provide an improved method and system for enabling and provisioning features within a motor drive.

### BRIEF DESCRIPTION

According to one embodiment of the invention, a method for enabling features in a motor drive includes obtaining a secure certificate in the motor drive, decrypting the secure certificate with a private key stored in memory of the motor drive, identifying at least one feature for execution on the motor drive defined in an extension of the secure certificate, and enabling a series of instructions for execution by the motor drive as a function of the at least one feature identified in the extension of the secure certificate.

According to another embodiment of the invention a system for enabling features in a motor drive includes a memory and a processor in the motor drive. The memory is configured to store multiple instructions, multiple parameters, a private key, and a secure certificate. The processor is configured to execute the instructions to obtain the secure certificate, decrypt the secure certificate using the private key, and identify at least one feature for execution on the motor drive, where the at least one feature is defined in the secure certificate. The processor is further configured to enable an additional series of instructions for execution by the motor drive as a function of the at least one feature identified in the secure certificate.

According to still another embodiment of the invention, a method for enabling features in a motor drive includes obtaining a certificate in the motor drive via a secure communication channel from a certificate provider, reading at least one desired feature for execution on the motor drive from an extension of the certificate, and enabling a series of instructions for execution by the motor drive as a function of the at least one desired feature identified in the extension of the certificate.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is an exemplary industrial control system in which embodiments of the present invention are incorporated;

FIG. 2 is a partial block diagram representation of the exemplary industrial control system of FIG. 1

FIG. 3 is a block diagram representation of the motor drive of FIG. 1 incorporating one embodiment of the present invention;

FIG. 4 is a block diagram representation of a rectifier section from the motor drive of FIG. 3;

FIG. 5 is a block diagram representation of an inverter section and gate driver module from the motor drive of FIG. 3;

FIG. 6 is a block diagram representation of one embodiment of a controller for the motor drive of FIG. 1

FIG. 7 is a block diagram representation of a power control section of the controller for the motor drive of FIG. 1; and

FIG. 8 is an exemplary certificate utilized by one embodiment of the present invention.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved method and system for enabling and provisioning features within a motor drive. A motor drive may be shipped with a minimal number of features preloaded and/or enabled on the motor drive. The features include, for example, an operating system, at least one basic motor control routine, network communication, and fault notification. The operating system provides a basic menu for navigation of the drive parameters required for the base functions, and the basic motor control routines enable control of a motor. The motor drive includes sufficient memory storage and processing capabilities to support these base functions. The motor drive also includes additional memory storage and processing capabilities for at least a portion of the total additional features which may be implemented in the motor drive. The motor drive may include expansion slots for the insertion of additional memory cards and/or processing devices if the number of additional features desired in the motor drive exceeds the capacity of the memory and processing provided with the basic motor drive.

The desired features to be performed by the motor drive are identified by a secure certificate provided to the motor drive. It is desirable to provide secure delivery of features to ensure the features being executed on the motor drive are authentic and provided by the supplier of the motor drive. A private key is stored in the motor drive, and the secure certificate is encrypted by the supplier with a corresponding public key. A customer identifies which features should be added and/or enabled on the motor drive according to application requirements. A manufacturer generates a certificate which identifies these features, and the encrypted certificate is delivered via a secure channel to the motor drive. The motor drive decrypts the certificate and reads the desired features for inclusion in the motor drive from extensions defined within the certificate. The motor drive is then able to download instructions for execution on the motor drive as well as configuration parameters required to execute the desired features. The instructions and parameters are stored in the memory of the motor drive for subsequent execution. Identification of features by secure certificate allows for feature and time-based licensing of functions for execution by the motor drive.

Optionally, a library of features may also be stored on the motor drive. Initially, only the basic features are enabled and accessible via the menu tree. The desired features are identified by the secure certificate provided to the motor drive, where the secure certificate is preferably delivered in a secure manner as discussed above. The motor drive decrypts the certificate and reads the desired features for activation in the motor drive from extensions defined within the certificate. The motor drive enables features from the library and incorporates required parameters for execution of these features in the menu tree. Thus, only those features to be executed on the motor drive are enabled and accessible for configuration.

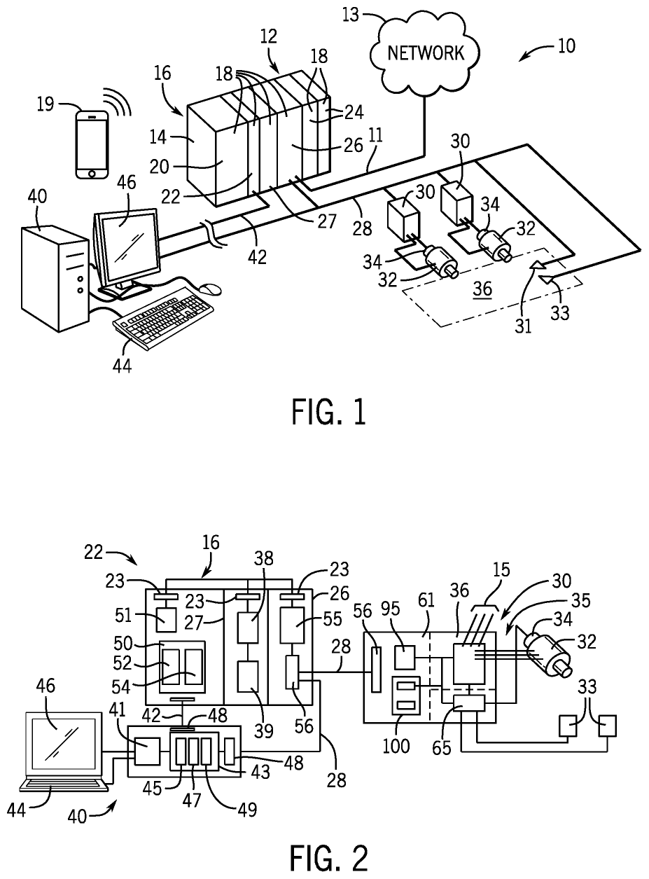

Referring initially to FIG. 1, an industrial control system 10 may include an industrial controller 12 providing multiple modules 18 and a bus 16 providing communication between the multiple modules 18. The modules 18 may be installed within a housing or on a mounting bracket, such as a DIN rail. The bus 16 is typically a backplane coupled between modules 18 via suitable connectors. The modules may include, for example, a power supply module 20, a processor module 22, one or more I/O modules 24, a motion control module 27, and a network module 26. The network module 26, processor module 22, or a combination thereof may communicate on an industrial control network 28, such as ControlNet®, DeviceNet®, or EtherNet/IP®, between the industrial controller 12 and other devices connected to the industrial controller. The network module 26 may also be connected to another network 13, in addition to the industrial control network 28, via a suitable network connection 11. The additional network 13 may include an intranet within a facility housing the industrial control system 10, the Internet, or a combination thereof. The network connection 11 may include network cables, such as Ethernet cables; wireless communications, such as Wi-Fi defined in IEEE 802.11 standards; or a combination thereof. In still other embodiments of the invention, the industrial control system 10 may be isolated from an external network. A mobile device 19, such as that disclosed in U.S. Pat. No. 10,721,223, may be utilized to connect the industrial control system 10 to an external network 13 for secure communication. U.S. Pat. No. 10,721,223 is co-owned by the Applicant and is incorporated in its entirety herein by reference. The industrial controller 12 may be, for example, a programmable logic controller (PLC), a programmable automation controller (PAC), or the like. It is contemplated that the industrial controller 12 may include still other modules, such as an axis control module, or additional racks connected via the industrial control network 28. Optionally, the industrial controller 12 may have a fixed configuration, for example, with a predefined number of network and I/O connections.

The industrial control network 28 may join the industrial controller 12 to remote I/O modules (not shown) and one or more remote motor drives 30, the latter of which may communicate with corresponding electric motors 32 and position sensors 34 to provide for controlled motion of the electric motors 32. The controlled motion of the electric motors, in turn, controls associated industrial machinery or processes 36. While a single motor drive and motor may be referred to as an axis of motion, an axis of motion may also require multiple motors controlled by a single motor drive or multiple motor drives and multiple motors operating in tandem. The network 28 may also join with other devices 31, 33 in the controlled machine or process 36, including, for example, actuators 31, controlled by output signals from the industrial controller 12, or sensors 33, providing input signals to the industrial controller.

A configuration computer 40 may communicate with the industrial controller 12 and/or the motor drives 30 over the industrial control network 28 or via a dedicated communication channel 42, for example, connecting with the processor module 22. The configuration computer 40 may be a standard desktop or laptop computer and include a keyboard 44, display screen 46, and the like to permit the entry and display of data and the operation of a configuration program by a human operator.

Referring next to FIG. 2, the processor module 22 includes a processor 51 communicating with a memory device 50 to execute an operating system program 52, generally controlling the operation of the processor module 22, and a control program 54, describing a desired control of the industrial machine or process 36, where each control program 54 is typically unique to a given application of the industrial control system 10. The memory 50 may also include data tables, for example, I/O tables and service routines (not shown in FIG. 2) as used by the control program 54.

The processor module 22 communicates via the bus 16, illustrated as a backplane 25 extending between backplane connectors 23, with the network module 26 or any of the other modules 18 in the industrial controller 12. The network module 26 includes a control circuit 55, which may include a microprocessor and a program stored in memory and/or dedicated control circuitry such as an application specific integrated circuit (ASIC) or field programmable gate array (FPGA). The control circuit 55 may communicate with a network interface circuit 56 within the network module 26, where the network interface circuit 56 provides for execution of low-level electrical protocols on the industrial control network 28 or on the additional network 13. Similar network interface circuits 56 may be provided on other devices, such as the motor drives 30, to provide communication between devices.

According to the illustrated embodiment, a motion control module 27 determines motion profiles for one or more of the motors 32 to follow. The motion profile may include a position reference signal (θ*), a velocity reference signal (ω*), an acceleration reference signal (α*), a Torque reference signal (T*), or a combination thereof to define the desired motion profile. The motion control module 27 includes a processor 38 in communication with a memory device 39 to execute one or more motion profile generators. It is contemplated that the motion control module 27 may execute a separate motion profile generator for each axis of motion. The reference signal, or signals, are transmitted from the motion control module 27 via the backplane 25 to the network module 26 and then via the industrial control network 28 to each motor drive. In some embodiments of the invention, it is contemplated that the processor module 22 may be configured to generate the motion profile for each axis and, in turn, generate the position reference signal (θ*), the velocity reference signal (ω*), the acceleration reference signal (α*), the Torque reference signal (T*), or a combination thereof.

As noted above, the configuration computer 40 may be a standard desktop computer having a processor 41 communicating with a memory 43, the latter holding an operating system program 45 as well as various data structures 47 and programs 49. One such program 49 may be used to configure the industrial control system 10. The configuration computer 40 may also provide for interface circuits 48 communicating between the processor 41, for example, and the industrial network 28 or a separate communication channel 42 to the processor module 22, as well as with the screen 46 and keyboard 44 according to methods understood in the art.

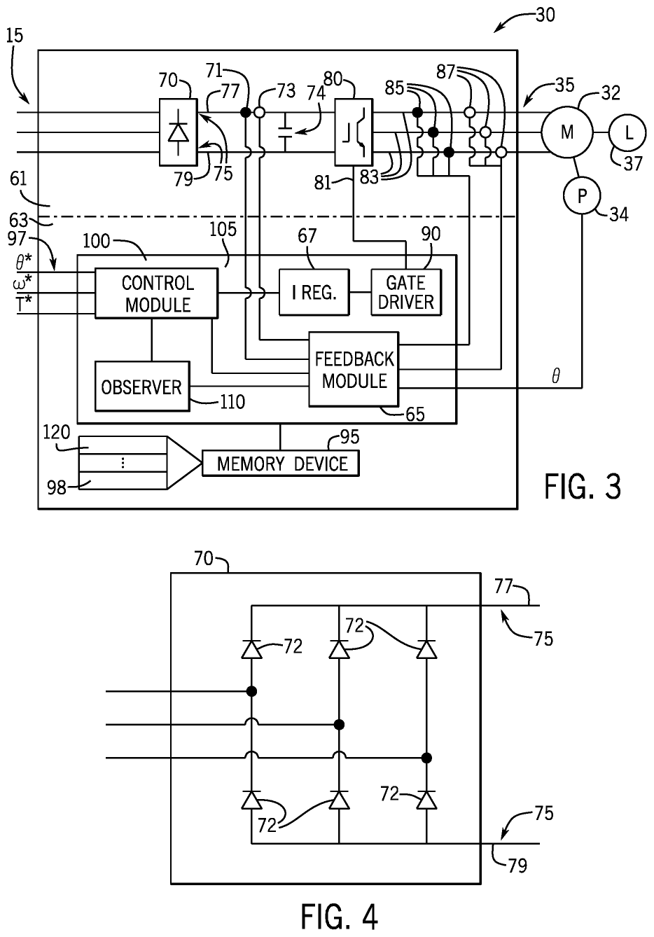

Turning next to FIG. 3, a motor drive 30, according to one embodiment of the invention, includes a power section 61 and a control section 63. The power section 61 includes components typically handling, for example, 200-575 VAC or 200-800 VDC. The power section 61 receives power in one form and utilizes power switching devices to regulate power output to the motor 32 in a controlled manner to achieve desired operation of the motor 32. The control section 63 includes components typically handling, for example 110 VAC or 3.3-50 VDC. The control section 63 includes processing devices, feedback circuits, and supporting logic circuits to receive feedback signals and generate control signals within the motor drive 30.

According to the illustrated embodiment, the motor drive 30 is configured to receive a three-phase AC voltage at an input 15 of the motor drive 30 which is, in turn, provided to a rectifier section 70 of the motor drive 30. The rectifier section 70 may include any electronic device suitable for passive or active rectification as is understood in the art. With reference also to FIG. 4, the illustrated rectifier section 70 includes a set of diodes 72 forming a diode bridge that rectifies the three-phase AC voltage to a DC voltage on the DC bus 75. Optionally, the rectifier section 70 may include other solid-state devices including, but not limited to, thyristors, silicon-controlled rectifiers (SCRs), or transistors to convert the input power 15 to a DC voltage for the DC bus 75. The DC voltage is present between a positive rail 77 and a negative rail 79 of the DC bus 75. A DC bus capacitor 74 is connected between the positive and negative rails, 77 and 79, to reduce the magnitude of the ripple voltage resulting from converting the AC voltage to a DC voltage. It is understood that the DC bus capacitor 74 may be a single capacitor or multiple capacitors connected in parallel, in series, or a combination thereof. The magnitude of the DC voltage between the negative and positive rails, 79 and 77, is generally equal to the magnitude of the peak of the AC input voltage.

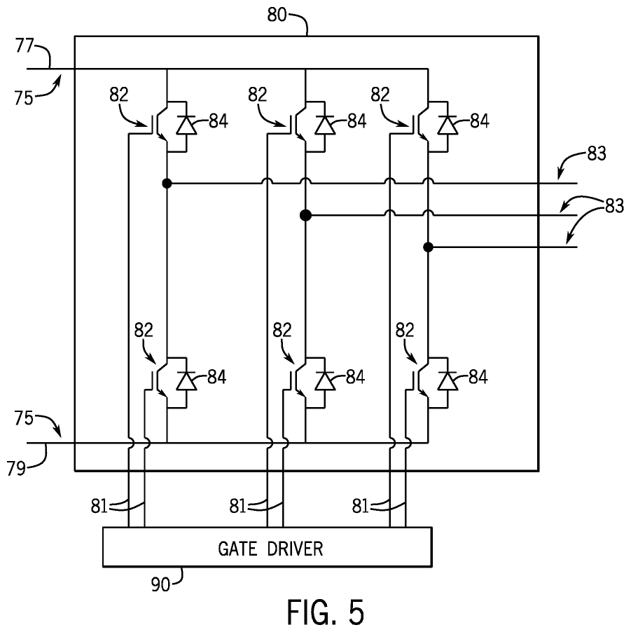

The DC bus 75 is connected in series between the rectifier section 70 and an inverter section 80. Referring also to FIG. 5, the inverter section 80 consists of switching elements, such as transistors, thyristors, or SCRs as is known in the art. The illustrated inverter section 80 includes an insulated gate bipolar transistor (IGBT) 82 and a free-wheeling diode 84 connected in pairs between the positive rail 77 and each phase of the output voltage as well as between the negative rail 79 and each phase of the output voltage. Each of the IGBTs 82 receives gating signals 81 to selectively enable the transistors 82 and to convert the DC voltage from the DC bus 75 into a controlled three phase output voltage to the motor 32. When enabled, each transistor 82 connects the respective rail 77, 79 of the DC bus 75 to an electrical conductor 83 connected between the transistor 82 and the output terminal 35. The electrical conductor 83 is selected according to the application requirements (e.g., the rating of the motor drive 30) and may be, for example, a conductive surface on a circuit board to which the transistors 82 are mounted or a bus bar connected to a terminal from a power module in which the transistors 82 are contained. The output terminals 35 of the motor drive 30 may be connected to the motor 32 via a cable including electrical conductors connected to each of the output terminals 35.

One or more modules are used to control operation of the motor drive 30. According to the embodiment illustrated in FIG. 3, a controller 100 includes the modules and manages execution of the modules. The illustrated embodiment is not intended to be limiting and it is understood that various features of each module discussed below may be executed by another module and/or various combinations of other modules may be included in the controller 100 without deviating from the scope of the invention. The modules may be stored programs executed on one or more processors, logic circuits, or a combination thereof. The controller 100 may be implemented, for example, in a microprocessor, application specific integrated circuit (ASIC), field programmable gate array (FPGA), or other such customizable device. The motor drive 30 also includes a memory device 95 in communication with the controller 100. The memory device 95 may include transitory memory, non-transitory memory, persistent memory, or non-persistent memory, or a combination thereof. The memory device 95 is configured to store data and programs, which include a series of instructions executable by the controller 100. The memory device 95 may be a single device, multiple devices, or incorporated, for example, as a portion of another device such as an application specific integrated circuit (ASIC). The controller 100 is in communication with the memory 95 to read the instructions and data as required to control operation of the motor drive 30.

The controller 100 receives a reference signal 97 identifying desired operation of the motor 32 connected to the motor drive 30. The reference signal 97 may be, for example, a position reference (θ*), a speed reference (ω*), a torque reference (T*), or a combination thereof. Although all three reference signals are illustrated in FIG. 3, commonly one of the three input signals is selected and provided to the motor drive 30. For a high-performance servo control system, the reference signal 97 is commonly a position reference signal (θ*). The controller 100 also receives feedback signals indicating the current operation of the motor drive 30. According to the illustrated embodiment, the controller 100 includes a feedback module 65 that may include, but is not limited to, analog to digital (A/D) converters, buffers, amplifiers, and any other components that would be necessary to convert a feedback signal in a first format to a signal in a second format suitable for use by the controller 100 as would be understood in the art. The motor drive 30 may include a voltage sensor 71 and/or a current sensor 73 on the DC bus 75 generating a feedback signal corresponding to the magnitude of voltage and/or current present on the DC bus 75. The motor drive 30 may also include one or more voltage sensors 85 and/or current sensors 87 on the output phase(s) of the inverter section 80 generating a feedback signal corresponding to the magnitude of voltage and/or current present on the electrical conductors 83 between the inverter section 80 and the output 35 of the motor drive. A position feedback device 34 may be connected to the motor 32 and operable to generate a position feedback signal, θ, corresponding to the angular position of the motor 32. The motor drive 30 includes an input configured to receive the position feedback signal from the position feedback device 34. It is contemplated that the input may be configured to receive a sinusoidal feedback signal, a square wave, a digital pulse train, a serial communication data packet, or a combination thereof according to the configuration of the position feedback device 34.

The controller 100 utilizes the feedback signals and the reference signal 97 to control operation of the inverter section 80 to generate an output voltage having a desired magnitude and frequency for the motor 32. The feedback signals are processed by the feedback module 65 and converted, as necessary, to signals for the control module 105.

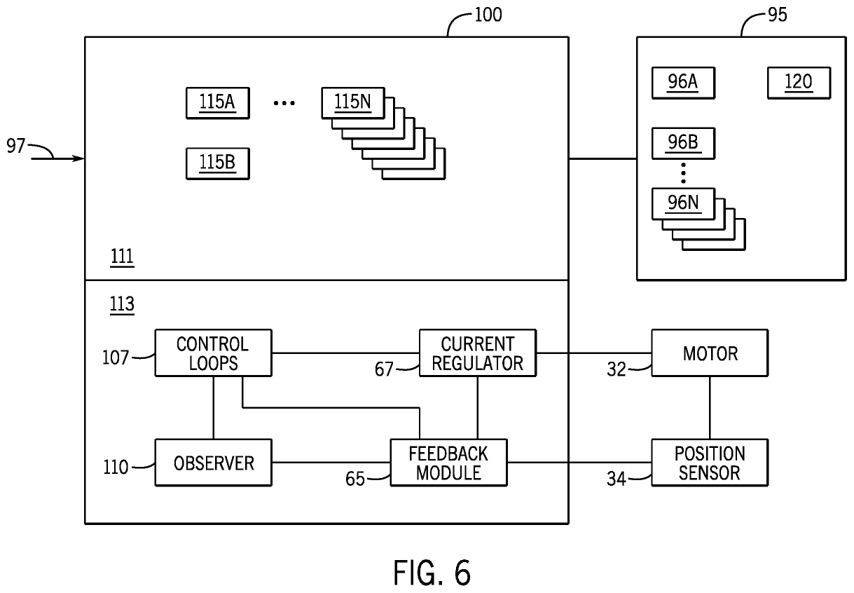

With reference also to FIG. 6, the control module 105 includes a system control section 111 and a power control section 113. The system control section 111 includes a plurality of modules 115 configured to execute system-level functions. The power control section 113 includes a plurality of modules (65, 67, 107, and 110) configured to execute motor control routines. The illustrated division is not intended to be limiting. It is understood that a module 115 executing in the system control section 111 may be implemented in part or in whole in the power control section 113 and a module executing in the power control section 113 may be implemented in whole or in part in the system control section 111. The illustrated division is intended to be exemplary and for convenience of discussion herein.

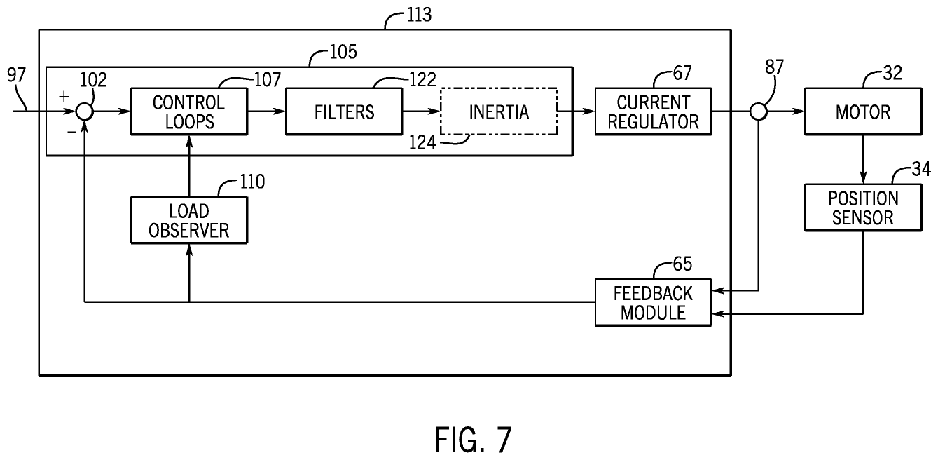

The power control section 113 includes, generally, modules required to convert a reference signal 97 to a voltage and/or current at the appropriate amplitude and frequency to control operation of the motor 32 according to the reference signal 97. With reference also to FIG. 7, the power control section 113 includes control loops 107 and filters 122. The power control section 113 receives the command signal 97 and a feedback signal, such as a position feedback signal, and executes responsive to the command signal 97 and the feedback signal to generate a desired output reference signal. The illustrated power control section 113 also includes a load observer 110 to generate an estimated response of one or more operating characteristics of the motor 32. The estimated response may be added to the reference signal from the control loops 107 to generate a modified reference signal. One or more filters 122 may be present in the control module 105 to reduce or eliminate undesired components of the modified reference signal. The output of the filter block 122 is a filtered output reference signal. As shown in FIG. 7, an optional inertia block 124 may be included in-line with the filters 122. The inertial gain may be included in the inertia block 124 or, optionally, may be incorporated into gains within the control loops 107 or within the filter block 122. The filtered reference signal is provided to the inertia block which outputs a current reference signal. The current reference signal is, in turn, output to the current regulator 67. As is understood in the art, the current regulator 67 may independently regulate a torque producing component of the current and a flux producing component of the current. The torque reference signal is provided as an input to the regulator controlling the torque producing component of the current. The current regulator 67 uses the torque reference signal and a current feedback signal to output a voltage signal to a gate driver module 90 (see also FIG. 3). The gate driver module 90 generates the gating signals 81, for example, by pulse width modulation (PWM) or by other modulation techniques. The gating signals 81 subsequently enable/disable the transistors 82 to provide the desired output voltage to the motor 32, which, in turn, results in the desired operation of the mechanical load 37 coupled to the motor 32. As is understood in the art, the current regulator 67 is configured to execute at a bandwidth sufficiently greater than the bandwidth of the control module 105 such that the current regulator 67 may be approximated as a unity gain to the control module 105. These functions are considered motor control routines as they are necessary for the motor drive 30 to achieve desired operation of the motor 32.

In addition to the motor control routines, the motor drive 30 is configured to execute one or more system-level modules 115. With reference again to FIG. 6, varying numbers of system-level modules 115 may be included. The illustrated embodiment includes a first system-level module 115A, a second system-level module 115B, and an extended number, up to “n” system-level modules 115n. Each system-level module 115 may be configured to perform a unique function within the motor drive 30. Exemplary system-level functions include, but are not limited to, brake control, energy management, flying start, and load monitoring. Each system-level module 115 may further include one or more parameters used to characterize, set up, or otherwise define operation of the module 115. As further shown in FIG. 6, a first parameter set 96A corresponds to the first system-level module 115A, a second parameter set 96B corresponds to the second system-level module 115B, and successive parameter sets up to the “nth” parameter set 96n correspond to each of the “n” system level modules 115n. Each parameter set may have one or more parameters. It is further contemplated that certain modules 115 may not require a parameter set and/or share parameters with other modules. A parameter storage region 98 (see FIG. 3) is defined in memory 95 of the motor drive 30 to store each of the parameter sets 96.

As previously discussed, the motor drive 30 is initially configured to include a basic level of functionality. According to one embodiment of the invention, all available modules 115 for system-level functions as well as any modules required for the power control section 113 are stored in in a library of functions in memory 95. Similarly, all of the parameters required to configure each of the modules 115 are stored in memory 95. While including all of the modules and all of the parameters within the motor drive 30 will require a similar amount of memory to be included in the motor drive 30 to the applications discussed in the background section above, significant savings with respect to processing demands and navigation complexity may still be achieved. A limited number of the modules 115 may initially be enabled to execute. Only those modules 115 enabled to function actually utilize processing overhead from the processor for the motor drive. Similarly, a limited number of parameter sets 96 may be displayed on a keypad for the motor drive 30 or be accessible via a remote device in communication with the motor drive 30. Thus, the processing overhead and navigation complexity for parameters is significantly improved.

According to another embodiment of the invention, only those modules 115 required to implement the basic level of functionality and the parameter sets 96 required to implement the initial set of modules are stored in memory 95 of the motor drive 30. It is contemplated that the total memory 95 included in the motor drive 30 is less than that required for storing all of the module and all of the parameter sets. Sufficient additional capacity in memory 95 may be included for a typical configuration of the motor drive 30 while not requiring memory capacity for all of the modules 115 and all of the associated parameters, thereby further reducing the cost of the motor drive 30. Additional modules 115 and parameter sets 96 may be enabled according to an application's requirements. Optionally, the motor drive 30 may include expansion slots and/or allow for memory within the motor drive 30 to be exchanged for larger capacity if the number of desired modules 115 and the associated parameter set exceeds the storage capacity within the motor drive 30.

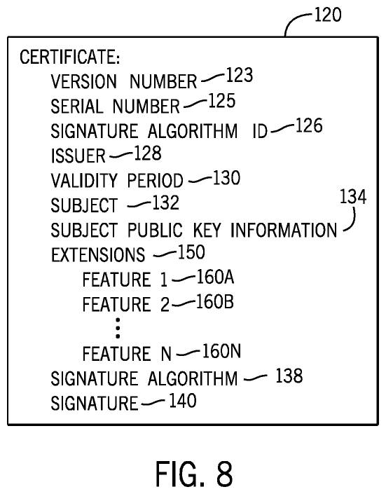

With reference to FIG. 8, a secure certificate 120 is utilized to enable additional modules 115 and/or add additional parameter sets 96 to the menu for each motor drive 30. The certificate 120 illustrated in FIG. 8 is exemplary and is not intended to be limiting. A number of fields are illustrated. It is understood that some of the fields may not be included in some applications and that additional fields may be required in other applications. The certificate 120 may be configured according to International Telecommunications Union (ITU) X.509 standard binding a public key to a signature for secure transmission of the certificate. According to the illustrated embodiment, the certificate includes: a version number 123, a serial number 125, a signature algorithm identifier 126, an indication of the issuer 128, a validity period 130, a subject 132, details in the public key 134, a signature algorithm 138, a signature 140, and extensions 150. The certificate 120 is generated by the supplier of the motor drive 30. An end user requests certain features 160 to be enabled within the motor drive 30 when the motor drive is purchased, and the supplier includes a list of the desired features 160 within the extensions 150 for the certificate 120.

In order to ensure that the motor drive 30 is only executing those features desired by a costumer and, similarly, to ensure that the features desired by a customer are enabled within the motor drive 30, it is desirable to ensure secure delivery of the certificate 120 to the motor drive 30. According to one aspect of the invention, the certificate 120 is loaded into the motor drive 30 at the factory. A certificate 120 may be generated corresponding to an order by a customer where the desired features 160 for the motor drive 30 are stored in the extensions 150 of the certificate, and the certificate 120 is stored in memory 95. According to another aspect of the invention, the motor drive 30 may establish a secure communication connection with a certificate provider. The certificate provider may be the manufacturer of the motor drive 30 or a third party providing generation and delivery of the certificates 120 as a service. The secure communication connection may be established using, for example, a user name and password login process, multi-factor authentication, or any other method of establishing secure communication. Once the secure communication channel is established, the motor drive 30 may request the certificate and the certificate provider transmits the certificate 120 to the motor drive 30. By allowing a certificate 120 to be downloaded, a consumer may be able to keep a reduced number of spare motor drives 30 for maintenance purposes. A process line, for example, may include tens or hundreds of motor drives, where each motor drive may require a different configuration. Rather than maintaining spare drives for each configuration, a reduced number of motor drives with the basic configuration may be stored. When a replacement motor drive is required to be installed in the process line, a certificate 120 specifying the desired configuration corresponding to the motor drive to be replaced may be downloaded and the appropriate modules 115 are enabled to achieve the required configuration for the replacement drive.

In order to obtain a certificate 120 from a remote certificate provider, a communication channel must be established. According to one aspect of the invention, the motor drive 30 is connected to the industrial controller 12 via an industrial network 28 as shown in FIG. 1. The industrial controller 12 is, in turn, connected to an additional network 13 for communication with the certificate provider. The additional network 13 may be an intranet within the facility in which the industrial control system 10 is installed. An additional processing device may provide a secure connection between the industrial control system 10 and an external network such as the Internet. Optionally, the additional network may be the Internet and secure communication via the Internet is handled directly by the industrial controller 12. According to still another option, the industrial controller 12 may be isolated from an external network such as the Internet to prevent undesired access to the industrial controller 12 from external sources. A mobile device 19, such as that disclosed in U.S. Pat. No. 10,721,223, may be utilized to connect the industrial control system 10 to an external network 13 for secure communication. The mobile device 19 may establish a secure communication channel with the certificate provider and a separate communication channel with the industrial controller 12 and relay messages between the industrial controller 12 and the certificate provider. According to still another option, the mobile device 19 may establish a secure communication channel with the certificate provider and a separate communication channel directly to the motor drive 30, relaying messages between the motor drive 30 and the certificate provider.

In addition to establishing a secure communication channel by which a certificate 120 is delivered, the certificate 120 itself may be encrypted. A public/private key pair is established for each motor drive 30. The private key is stored on the motor drive 30 and the public key is provided to the certificate provider. After generating the certificate 120, the certificate provider encrypts the certificate 120 using the public key. Only the motor drive 30 for which the certificate 120 is intended includes the private key by which the encrypted certificate 120 may be decrypted.

Upon receipt of the encrypted certificate 120 via a secure communication channel, the motor drive 30 decrypts the certificate 120 and reads the desired features 160 from the extensions 150 in the certificate to determine which features should be enabled on the motor drive 30. According to one embodiment, the motor drive 30 may identify modules 115 stored in the library on the motor drive 30 which correspond to the desired features 160 defined in the certificate 120. Each module 115 may correspond directly to a desired feature 160. For example a first feature 160A defined in the certificate 120 may correspond to a first module 115A stored in the motor drive 30. A second feature 160B defined in the certificate 120 may correspond to a second module 115B stored in the motor drive 30. This may continue for “n” features 160 and “n” modules 115. Optionally, one feature 160 defined in the certificate 120 may correspond to two or more modules 115 stored in the motor drive 30. When the modules 115 are stored as library functions, the motor drive 30 is configured to enable each of the desired modules 115 stored on the motor drive 30 according to the features 160 defined in the certificate 120.

According to another embodiment, the motor drive 30 only includes the basic modules 115 initially stored on the motor drive 30 when it receives the certificate 120. The motor drive 30 again reads the desired features 160 from the extensions 150 in the certificate and takes steps to obtain the corresponding modules 115 from a remote server. According to one aspect of the invention, the modules 115 may be stored on a server in communication with the certificate provider. The motor drive 30 may utilize the secure communication channel by which it obtained the certificate 120 to download each of the additional modules 115 required to execute the desired features 160. According to another aspect of the invention, the modules 115 may be stored on a remote server separate from the certificate provider. The motor drive 30 may establish another communication channel via the industrial network 28, additional network 13, mobile device 19, or any combination of the above between the motor drive 30 and the remote server on which the modules 115 are stored. The motor drive 30 downloads each of the modules 115 corresponding to the desired features 160 and stores them in memory 95 on the motor drive.

After obtaining and/or enabling the desired modules 115, the motor drive 30 also enables corresponding parameter sets 96 by which the modules 115 are configured. Default values for each parameter may be previously stored in memory. Optionally, default values for parameters may be downloaded in conjunction with downloading the modules 115 for execution. If a motor drive 30 includes a display device, the additional parameter sets 96 are added to the menu tree such that the parameters are visible to a technician and desired values for each parameter may be entered into the motor drive.

According to another aspect of the invention, other fields within the certificate 120 may be utilized for enabling the modules 115 within the motor drive 30. The validity period 130, for example, may define a duration in which the desired features 160 are enabled. A customer may request a time-limited license for a feature based on varying applications being performed by the industrial control system 10. A motor drive 30 may need to operate in one manner for a first period of time during the manufacture, assembly, or other processing performed by the controlled system. During this first period of time, a first set of features 160 may be required. The controlled system 10 may then be reconfigured for different operation and the motor drive 30 may require other features 160 to be enabled. Rather than purchasing separate, custom programmed motor drives or requiring one expensive motor drive 30 with all features enabled, a customer may license certain features 160 for a desired duration. The desired duration may be included in the validity period 130 by the certificate provider. The motor drive 30 may obtain and/or enable module 115 required by each desired feature 160 at the start of a time period and disable and/or delete modules 115 at the end of the desired duration. Thus, the certificate 120 may provide for time-limited licensing of features 160.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method for enabling features in a motor drive, comprising the steps of:
obtaining a secure certificate in the motor drive;
decrypting the secure certificate with a private key stored in memory of the motor drive;
identifying at least one feature for execution on the motor drive defined in an extension of the secure certificate; and
enabling a series of instructions for execution by the motor drive as a function of the at least one feature identified in the extension of the secure certificate.

2. The method of claim 1, wherein enabling the series of instructions further comprises the steps of:
obtaining the series of instructions from a remote server responsive to identifying the at least one feature;
storing the series of instructions in the memory of the motor drive; and
enabling the series of instructions for execution by the motor drive.

3. The method of claim 1, wherein enabling the series of instructions further comprises the step of enabling a library function stored in the memory on the motor drive.

4. The method of claim 1, wherein the step of obtaining the secure certificate further comprises establishing a secure channel between the motor drive and a certificate provider.

5. The method of claim 4, wherein the secure channel is established via either an intranet or an Internet connection between the motor drive and the certificate provider.

6. The method of claim 4, wherein the secure channel is established via a mobile device in communication with both the motor drive and the certificate provider.

7. The method of claim 1, further comprising the step of reading a validity period from the secure certificate, wherein the step of enabling the series of instructions for execution is limited in time to the validity period.

8. A system for enabling features in a motor drive, comprising:
a memory in the motor drive configured to store:
a plurality of instructions,
a plurality of parameters,
a private key, and
a secure certificate;
a processor in the motor drive, the processor configured to execute the plurality of instructions to:
obtain the secure certificate,
decrypt the secure certificate using the private key,
identify at least one feature for execution on the motor drive, the at least one feature defined in the secure certificate, and
enable an additional series of instructions for execution by the motor drive as a function of the at least one feature identified in the secure certificate.

9. The system of claim 8, further comprising a communication interface, the communication interface configured to communicate with a remote server, wherein the processor is further configured to execute the plurality of instructions to:
obtain the additional series of instructions from the remote server responsive to identifying the at least one feature;
store the additional series of instructions in the memory of the motor drive; and
enable the additional series of instructions for execution by the motor drive.

10. The system of claim 8, wherein enabling the additional series of instructions further comprises enabling a library function stored in the memory on the motor drive.

11. The system of claim 8, further comprising a communication interface, wherein obtaining the secure certificate further comprises establishing a secure channel between the motor drive and a certificate provider via the communication interface.

12. The system of claim 11, wherein the secure channel is established via either an intranet or an Internet connection between the motor drive and the certificate provider.

13. The system of claim 11, wherein the communication interface is configured to communicate with a mobile device and the secure channel is established to the certificate provider via the mobile device.

14. The system of claim 8, wherein the processor is further configured to execute the plurality of instructions to read a validity period from the secure certificate, wherein the step of enabling the additional series of instructions for execution is limited in time to the validity period.

15. A method for enabling features in a motor drive, comprising the steps of:
obtaining a certificate in the motor drive via a secure communication channel from a certificate provider;
reading at least one desired feature for execution on the motor drive from an extension of the certificate; and
enabling a series of instructions for execution by the motor drive as a function of the at least one desired feature identified in the extension of the certificate.

16. The method of claim 15, wherein enabling the series of instructions further comprises the steps of:
obtaining the series of instructions from a remote server responsive to identifying the at least one desired feature;
storing the series of instructions in memory of the motor drive; and
enabling the series of instructions for execution by the motor drive.

17. The method of claim 16, wherein the certificate provider is the same as the remote server.

18. The method of claim 15, wherein enabling the series of instructions further comprises the step of enabling a library function stored in memory on the motor drive.

19. The method of claim 15, wherein the secure communication channel is established via either an intranet or an Internet connection between the motor drive and the certificate provider.

20. The method of claim 19, wherein the secure communication channel is established via a mobile device in communication with both the motor drive and the certificate provider.
